(19) United States
(12) Patent Application Publication
(10) Pub. No.: US 2006/0063274 A1
(43) Pub. Date: Mar. 23, 2006

(54) Methods for manufacturing and using chemical array calibration devices

(76) Inventors: Donald J. Schremp, San Jose, CA (US); Bill J. Peck, Mountain View, CA (US); Stanley P. Woods, Cupertino, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/948,886

(22) Filed: Sep. 23, 2004

(51) Int. Cl. G01N 21/64

(52) U.S. Cl. 436/180; 436/172

(57) ABSTRACT

The invention provides methods for manufacturing a chemical array reader calibration device. Embodiments include dispensing a volume of fluorescent dye coating composition from a pulse jet fluid deposition device onto a surface of a substrate to coat the surface with the fluorescent dye coating composition. Also provided are chemical array reader calibration devices and methods of using the subject chemical array reader calibration devices to calibrate a chemical array reader. Also provided are kits that include a chemical array reader calibration device.

### BACKGROUND OF THE INVENTION

Chemical Arrays of biopolymeric binding agents have become an increasingly important tool in the biotechnology industry and related fields. These arrays, in which a plurality of biopolymeric binding agents are deposited onto a solid support surface in the form of an array or pattern, find use in a variety of applications, including gene expression analysis, drug screening, nucleic acid sequencing, mutation analysis, and the like.

In array-based assays in which an array of binding agents is employed, the array surface is typically contacted with one or more analytes, such as polynucleotide analytes, receptor proteins or antiligand molecules, under conditions that promote specific, high-affinity binding of the analyte molecules to one or more of the array members. Typically, the goal is to identify one or more position-addressable members of the library array which bind to the analyte, as a method of screening for array compounds which bind the analyte. Typically, the analytes are labeled with a detectable label such as a fluorescent agent, which indicates the regions in which analyte binding to the array has occurred.

Once the binding of the analyte to one or more array members has occurred, the arrays are read, usually by optical means, where a variety of optical array readers are available for reading such arrays (see for example U.S. Pat. Nos. 5,324,633 and 5,585,639, the disclosures of which are herein incorporated by reference). The optical means included in these array scanning devices typically includes a light source, e.g., a laser or the like, for transmitting light onto the array and a detector, e.g., a photomultiplier or the like, for detecting a parameter of the transmitted light, e.g., fluorescence, etc. Typically, data corresponding to the amount of light signal obtained for each pixel detected is produced by the scanner, and this data may be examined to evaluate the level of a particular analyte in a sample.

It is imperative that these array readers perform consistently. In other words, it is important that the light source and detector accurately and precisely detect the level of fluorescence across the entire surface of the array, and that such detection is consistent amongst scanners. Chemical array reader calibration devices have been developed so that an array reader may be periodically calibrated to achieve and maintain consistency, precision and accuracy, and to ensure that variations between readers are minimized. Devices and methods for calibrating array readers are described, for example, in US publication No. 20030165871.

As chemical arrays are used more and continue to play important roles in a variety of applications, there continues to be an interest in the development of calibration devices used to calibrate chemical array readers.

### SUMMARY OF THE INVENTION

The invention provides calibration devices for calibrating a chemical array reader and method of manufacturing such devices. Embodiments of the subject invention include methods for manufacturing fluorescent dye-coated chemical array reader calibration devices that include dispensing a volume of fluorescent dye coating composition from a pulse jet fluid deposition device onto a surface of a substrate to coat the substrate surface with the fluorescent dye coating composition, e.g., in a uniform coating. Also provided are fluorescent dye-coated chemical array reader calibration devices manufactured according to the subject methods, as well as kits that include a fluorescent dye-coated chemical array reader calibration device manufactured according to the subject methods.

The invention also provides methods for calibrating a chemical array reader using a fluorescent dye-coated chemical array reader calibration device manufactured according to the subject methods. Embodiments of the subject array reader calibration methods include illuminating a surface of a fluorescent dye-coated chemical array reader calibration device with at least one light source, obtaining fluorescent data from the surface of the calibration device and calibrating the chemical array reader based on the obtained fluorescence.

Also provided by the subject invention are methods of performing a chemical array assay, where embodiments include calibrating a chemical array reader with a fluorescent dye-coated chemical array reader calibration device, e.g., manufactured according to the subject methods, contacting a sample with a chemical array, and reading the chemical array with the calibrated array reader to obtain a result.

### BRIEF DESCRIPTIONS OF THE DRAWINGS

FIG. 1A shows an exemplary embodiment in which droplets from a pulse jet fluid deposition device are dispensed on a substrate surface so that they contact each other according to the subject invention.

FIG. 1B shows an exemplary embodiment in which droplets from a pulse jet fluid deposition device are dispensed on a substrate surface so that they do not contact each other or overlap each other according to the subject invention.

FIG. 1C that shows an exemplary embodiment in which droplets of varying volumes are dispended from a pulse jet fluid deposition device onto a substrate surface, i.e., not all the droplets are the same size.

FIG. 2 shows an exemplary embodiment in which droplets dispensed from a pulse jet fluid deposition device have coalesced together to provide a uniform coating layer on a substrate surface other according to the subject invention.

### DEFINITIONS

A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. Specifically, a “biopolymer” includes DNA (including cDNA), RNA and oligonucleotides, regardless of the source.

A “monomer” references a single unit, which can be linked with the same or other monomers to form a polymer (for example, a single amino acid or nucleotide with two linking groups one or both of which may have removable protecting groups). A monomer fluid or polymer fluid reference a liquid containing either a monomer or polymer, respectively (typically in solution).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

Reference to a “droplet” or “drop” merely refers to a discrete small quantity of fluid and does not require any particular shape. For example, reference to a “droplet” being dispensed from a pulse jet herein, merely refers to a discrete small quantity of fluid (usually less than about 1000 pL) being dispensed upon a single pulse of the pulse jet (corresponding to a single activation of an ejector) and does not require any particular shape of this discrete quantity.

When two items are “associated” with one another they are provided in such a way that it is apparent that one is related to the other such as where one references the other.

“Fluid” is used herein to reference a liquid.

Items of data are “linked” to one another in a memory when a same data input (for example, filename or directory name or search term) retrieves those items (in a same file or not) or an input of one or more of the linked items retrieves one or more of the others. In particular, when error information, array layout information, etc., is “linked” with an identifier for that array, then an input of the identifier into a processor which accesses a memory carrying the linked array layout retrieves the error information, array layout, etc. for that array.

A “reader” or “chemical array reader” refers to any device for evaluating chemical arrays, including an array imager and an array scanner. An “array imager” captures a two-dimensional wide-field image of an array, e.g., an entire array or multi-pixel region thereof, and may employ a CCD or other detector. An “array scanner” moves a field of illumination across an array, typically in a line or series of lines, and reads light emitted from the array. In many scanners, an optical light source, particularly a laser light source, generates a collimated beam. The collimated beam is focused on the array and sequentially illuminates small surface regions of known location (i.e. a position) on an array substrate. The resulting signals from the surface regions are collected either confocally (employing the same lens used to focus the light onto the array) or off-axis (using a separate lens positioned to one side of the lens used to focus the onto the array). The collected signals are then transmitted through appropriate spectral filters, to an optical detector. A recording device, such as a computer memory, records the detected signals and builds up a raster scan file of intensities as a function of position, or time as it relates to the position. Such intensities, as a function of position, are typically referred to in the art as “pixels”. Biopolymer arrays are often scanned and/or scan results may be represented at about 5 or about 10 micron pixel resolution. To achieve the precision required for such activity, components such as the lasers must be set and maintained with particular alignment. Scanners may be bi-directional, or unidirectional, as is known in the art.

The scanner used for the evaluation of arrays typically includes a scanning fluorimeter. A number of different types of such devices are commercially available from different sources, such as such as Perkin-Elmer, Agilent Technologies (e.g., DNA MICROARRAY SCANNER model no. G2565BA), Axon Instruments, etc., and examples of typical scanners are described, for example, in U.S. Pat. Nos. 5,091,652; 5,585,639; 5,760,951; 5,763,870; 5,837,475; 6,084,991; 6,222,664; 6,284,465; 6,320,196; 6,329,196; 6,366,365; 6,371,370; 6,355,934 and 6,406,849.

A chemical “array”, unless a contrary intention appears, includes any one, two or three-dimensional arrangement of addressable regions bearing a particular chemical moiety or moieties (for example, biopolymers such as polynucleotide sequences) associated with that region. For example, each region may extend into a third dimension in the case where the substrate is porous while not having any substantial third dimension measurement (thickness) in the case where the substrate is non-porous. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). Such a region may be referred to as a “feature region”. The target for which each feature is specific is, in representative embodiments, known. An array feature is generally homogenous in composition and concentration and the features may be separated by intervening spaces (although arrays without such separation can be fabricated).

The term “binding” refers to two objects associating with each other to produce a stable composite structure. Such a stable composite structure may be referred to as a “binding complex”. In certain embodiments, binding between two complementary nucleic acids may be referred to as specifically hybridizing. The terms “specifically hybridizing,” “hybridizing specifically to” and “specific hybridization” and “selectively hybridize to,” are used interchangeably and refer to the binding, duplexing, complexing or hybridizing of a nucleic acid molecule preferentially to a particular nucleotide sequence under stringent conditions. “Hybridizing” and “binding”, with respect to polynucleotides, are used interchangeably.

In the case of an array, the “target” will be referenced as a moiety in a mobile phase (typically fluid), such as a sample, to be detected by probes (e.g., cytotoxic probes) which are bound to the substrate at the various regions. However, either of the “target” or “target probes” may be the one which is to be detected by the other (thus, either one could be an unknown mixture of polynucleotides to be detected by binding with the other). “Addressable set of probes” and analogous terms refers to the multiple regions of different moieties supported by or intended to be supported by the array surface.

An “array layout” or “array characteristics”, refers to one or more physical, chemical or biological characteristics of the array, such as positioning of some or all the features within the array and on a substrate, one or more feature dimensions, or some indication of an identity or function (for example, chemical or biological) of a moiety at a given location, or how the array should be handled (for example, conditions under which the array is exposed to a sample, or array reading specifications or controls following sample exposure).

“Reading” signal data, e.g., from an array or calibration device refers to the detection of the signal data (such as by a detector) from the array. This data may be saved in a memory (whether for relatively short or longer terms).

The term “reference” is used to refer to a known value or set of known values against which an observed value may be compared.

A “plastic” is any synthetic organic polymer of high molecular weight (for example at least 1,000 grams/mole, or even at least 10,000 or 100,000 grams/mole.

“Flexible” with reference to a substrate or substrate web, references that the substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C. “Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

When one item is indicated as being “remote” from another, this is referenced that the two items are at least in different buildings, and may be at least one mile, ten miles, or at least one hundred miles apart. When different items are indicated as being “local” to each other they are not remote from one another (for example, they can be in the same building or the same room of a building). “Communicating”, “transmitting” and the like, of information reference conveying data representing information as electrical or optical signals over a suitable communication channel (for example, a private or public network, wired, optical fiber, wireless radio or satellite, or otherwise). Any communication or transmission can be between devices which are local or remote from one another. “Forwarding” an item refers to any means of getting that item from one location to the next, whether by physically transporting that item or using other known methods (where that is possible) and includes, at least in the case of data, physically transporting a medium carrying the data or communicating the data over a communication channel (including electrical, optical, or wireless). “Receiving” something means it is obtained by any possible means, such as delivery of a physical item (for example, an array or array carrying package). When information is received it may be obtained as data as a result of a transmission (such as by electrical or optical signals over any communication channel of a type mentioned herein), or it may be obtained as electrical or optical signals from reading some other medium (such as a magnetic, optical, or solid state storage device) carrying the information. However, when information is received from a communication it is received as a result of a transmission of that information from elsewhere (local or remote).

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly.

A “computer”, “processor” or “processing unit” are used interchangeably and each references any hardware or hardware/software combination which can control components as required to execute recited steps. For example a computer, processor, or processor unit may include a general purpose digital microprocessor suitably programmed to perform all of the steps required of it, or any hardware or hardware/software combination which will perform those or equivalent steps.

Programming may be accomplished, for example, from a computer readable medium carrying necessary program code (such as a portable storage medium) or by communication from a remote location (such as through a communication channel).

A “memory” or “memory unit” refers to any device which can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

To “record” data, programming or other information on a computer-readable medium refers to a process for storing information, using any such methods as are known in the art. Any convenient storage structure may be chosen, based on the means to access the stored information. A variety of data processor programs and formats may be used for data storage, e.g., word processing text file, databases format, etc.

An array “assembly” includes a substrate and at least one chemical array on a surface thereof. An assembly may include other features (such as a housing with a chamber from which the substrate sections can be removed). “Array unit” may be used interchangeably with “array assembly”.

It will also be appreciated that throughout the present application, that words such as “cover”, “base” “front”, “back”, “top”, bottom, “upper”, and “lower” are used in a relative sense only.

“May” refers to optionally.

When two or more items (for example, elements or processes) are referenced by an alternative “or”, this indicates that either could be present separately or any combination of them could be present together except where the presence of one necessarily excludes the other or others.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formnamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

As used herein, the term “contacting” means to bring or put together. As such, a first item is contacted with a second item when the two items are brought or put together, e.g., by touching them to each other.

“Depositing” means to position, place an item at a location-or otherwise cause an item to be so positioned or placed at a location. Depositing includes contacting one item with another. Depositing may be manual or automatic, e.g., “depositing” an item at a location may be accomplished by automated robotic devices.

The term “sample” as used herein refers to a fluid composition.

The term “assessing” and “evaluating” are used interchangeably to refer to any form of measurement, and includes determining if an element is present or not. The terms “determining,” “measuring,” and “assessing,” and “assaying” are used interchangeably and include both quantitative and qualitative determinations. Assessing may be relative or absolute. “Assessing the presence of” includes determining the amount of something present, as well as determining whether it is present or absent.

The term “using” has its conventional meaning, and, as such, means employing, e.g. putting into service, a method or composition to attain an end. For example, if a program is used to create a file, a program is executed to make a file, the file usually being the output of the program. In another example, if a computer file is used, it is usually accessed, read, and the information stored in the file employed to attain an end.

Similarly if a unique identifier, e.g., a barcode is used, the unique identifier is usually read to identify, for example, an object or file associated with the unique identifier.

The term “substantially uniform size” means that the diameter of each of the referenced items does not vary significantly, e.g., does not vary by more than about 50%, e.g., not more than about 25%, e.g., not more than about 5% to about 0% in certain embodiments.

A “pulse jet” is a device which can dispense drops. Pulse jets operate by delivering a pulse of pressure to liquid adjacent an outlet or orifice (such as by a piezoelectric or thermoelectric element positioned near the orifice) such that a drop will be dispensed therefrom.

“Background signal” refers to the amount of signal generated from one or more non-fluorescent areas.

The “surface energy” (measured in ergs/cm²) of a liquid or solid substance pertains to the free energy of a molecule on the surface of the substance, which is necessarily higher than the free energy of a molecule contained in the in the interior of the substance; surface molecules have an energy roughly 25% above that of interior molecules. The term “surface tension” refers to the tensile force tending to draw surface molecules together, and although measured in different units (as the rate of increase of surface energy with area, in dynes/cm (mN/m)), is numerically equivalent to the corresponding surface energy.

The term “contact angle” as used herein relates to a measure of wetting of a solid surface by a liquid. The contact angle refers to the angle between a flat solid surface and the tangent to the liquid surface at the contact point. Contact angles may vary from 0° to 180°, inclusive. Lower contact angles indicate a high degree of wetting of the solid surface by the liquid. Non-wetting surfaces exhibit a high contact angle with respect to the liquid. A contact angle of 90° is defined as the boundary between non-wetting and wetting. A “sufficiently low contact angle” refers to a contact angle less than about 50°, e.g., less than about 40°, e.g., less than about 30°, less than about 20° in certain embodiments e.g., using a glass substrate surface or the like.

A surface is said to be “lyophobic” with respect to a liquid when the surface exhibits a contact angle greater than 90° with respect to the liquid.

“Calibration region”, refers to a substrate surface area that includes fluorescent dye coating composition. For example, a calibration region may have a surface area of as small as about 10 μm or greater in certain embodiments. The limit is of course based on the sensitivity of the scanner used to read the calibration region. As such, the dimensions of a calibration region are exemplary only and are in no way intended to limit the scope of the invention. Calibration regions less than, and greater than 10 μm are contemplated by the subject invention.

“Uniform thickness” means that the deviation in the thickness of a deposited coating composition is less than about 0.05% to about 20% and more usually less than about 0.1% to about 10%.

“Uniform fluorescence”, uniform dye loading”, “uniform dye concentration”, are used interchangeably to refer to minimal local and global variations or nonumiformities of the dye concentration in a deposited coating composition in which the deviation in the concentration of dye of a deposited coating composition is less than about 0.05% to about 20% and more usually less than about 0.1% to about 10%.

By “local variations or nonuniformity” is meant that the light emitted from different pixels in a certain area or region has measurable difference, where it will be obvious that the exact local variation or nonuniformity requirement of the intensities of light emitted may vary depending on a variety of factors such as the specific device to be calibrated and the like.

By “global variation or nonuniformity” is meant a statistically relevant value (mean, median, etc.) corresponding to all or substantially all of the individual local variations of an entire readable area of a given calibration device.

By “absent fluorescent agent” is meant that there is less than about 5% of the molar amount of fluorescent agent in active form (i.e., the molar amount of fluorescent agent that fluoresces), usually less than about 2% the molar amount of fluorescent agent in active form. Regions that are absent fluorescent agent include photobleached regions.

### DETAILED DESCRIPTION OF THE INVENTION

The invention provides calibration devices for calibrating a chemical array reader and method of manufacturing such devices, where embodiments of the subject invention include methods for manufacturing fluorescent dye-coated chemical array reader calibration devices. Also provided are methods of calibrating a chemical array reader using a subject calibration device, as well as methods of using a reader calibrated using a fluorescent dye-coated chemical array reader calibration device manufactured according to the subject invention to read an array. The subject fluorescent dye-coated chemical array reader calibration devices find use in a variety of fluorescence readers, including biopolymeric array scanners.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The figures shown herein are not necessarily drawn to scale, with some components and features being exaggerated for clarity.

Method of Manufacturing a Chemical Array Reader Calibration Device

As mentioned above, the invention provides methods of making a chemical array reader calibration device (“calibration device”). While the subject methods may be used to manufacture a wide variety of calibration devices, embodiments are described primarily with respect to manufacturing calibration devices that include a substrate coated, e.g., in certain embodiments uniformly, with a fluorescent dye coating composition. It is to be understood that such description is for exemplary purposes only and is in no way intended to limit the scope of the subject invention. For example, the subject methods may be employed with any suitable array reader calibration composition, including but not limited to compositions that include a fluorescent agent as well as compositions that do not include a fluorescent agent.

A feature of embodiments of the subject invention is that the fluorescent dye coating composition (“composition” or “coating composition”) is dispensed from a pulse jet fluid deposition device onto a surface of a substrate to coat the surface with the composition, e.g., in a uniform coating. Such pulse jet fluid deposition devices may also be referred to as a pulse jet ejection devices.

Exemplary Pulse Jet Fluid Deposition Devices

Pulse jet deposition devices are known in the art. Embodiments of pulse jet fluid deposition devices that may find use with the subject methods include a dispensing head (or plurality of heads) which may be of a type commonly used in an ink jet type of printer and includes one or more, and in many embodiments a plurality, of dispensing orifices associated with a chamber. A head may, for example, have about 1 to about 512 or more orifices, each of which is associated with an ejector. Some or all of the orifices may a respective ejector or some or all may share an ejector. Each orifice with its associated ejector and chamber, defines a corresponding pulse jet with the orifice acting as a nozzle. It will also be understood that a head system may be employed that includes two, three or more heads which may be mounted on different holders or mounted on the same holder for movement in unison with one another (or may be mounted for independent movement).

A pulse jet fluid ejection device may be activated in a number of ways, e.g., by ultrasonic energy, mechanical energy, electrical energy, thermal energy, and the like. Examples of fluid ejection devices that are activated by mechanical, thermal or electrical energy include, e.g., inkjet-type devices and the like, for example that use a piezoelectric ejector element. In this manner, application of an electric pulse to an ejector causes a volume of fluid to be dispensed from a corresponding orifice. In certain embodiments each ejector may be in the form of an electrical resistor operating as a heating element under control of processor (although piezoelectric elements may be used instead).

The foregoing head system and other suitable dispensing head designs are described, e.g., in U.S. Pat. Nos. 6,461,812; 6, 440,669; 6,323,043; 6,599,693. However, other head system configurations may be used.

As embodiments of the subject invention include depositing a volume of coating composition from a pulse jet ejection device onto a substrate surface, the pulse jet device is in fluid communication with a reservoir containing the coating composition to be dispensed. As will be described in greater detail below, a pulse jet device may be in alternating fluid communication with a plurality of reservoirs, wherein the coating composition present in each reservoir may differ in at least one aspect from the coating composition present in one or more other reservoirs. For example, the concentration of coating composition, e.g., the concentration of fluorescent dye in the composition, may differ, such that a pulse jet device may dispense various concentrations of coating composition from the same or different orifice. Various valving systems may be employed to permit establishment and disengagement of various desired fluid communications, where a processor may control a valving system.

The particulars of a given pulse jet deposition device employed will vary depending on a variety of factors such as the particular coating composition deposited thereby, the type of energy used to activate the device, etc. In certain embodiments, a pulse jet device (e.g., a piezoelectric pulse jet device) employed is one that is adapted to dispense a small volume of coating composition through one or more orifices to provide a calibration coating of uniform thickness and/or uniform dye concentration on a continuous region of the surface of a substrate. For example, the coating composition may be dispensed from a pulse jet as particles or droplets of substantially uniform volume, which particles merge together at the surface to provide a calibration coating of uniform thickness and/or uniform dye concentration, as described below. Accordingly, a given nozzle of a pulse jet device is dimensioned to dispense fluid of sufficient volume at particular deposition rate without clogging of a nozzle. As describe below, fluid of different volumes may be dispensed from the same or different nozzle to form a calibration coating, i.e., the droplets of composition coating fluid need not all be of the same volume.

Exemplary Calibration Coating Compositions

As noted above, the subject methods may be employed to coat a substrate surface with a wide variety of calibration coating compositions. In certain embodiments, the coating composition is a fluorescent dye coating composition in that it includes at least one fluorescent agent. In certain embodiments, the composition includes fluorescent agent and a solvent or the like, e.g., a polymeric composition that includes one or more fluorescent agents. Calibration coating compositions do not include nucleic acids.

In certain embodiments, the viscosity of a coating composition employed in the practice of the subject methods may range from about 1 centipoise to about 20 centipoise, e.g., from about 10 centipoise to about 100 centipoise.

In order to spread over the surface of the substrate and provide a coating of uniform thickness and uniform dye concentration, the dispensed coating composition should be such that have a suitable contact angle when deposited at the substrate, e.g., a sufficiently low contact angle.

A variety of polymers may be used in such calibration compositions, where such polymers will typically be thermally stable, photo non-reactive, non-fluorescent, and substantially transparent across the wavelength region of interest. Representative materials suitable for use include, but are not limited to, acrylates such as polyacrylates, polymethyl-methacrylate, polyacrylamide, polyacrylic acid, epoxides such as polyglycidoxyether polyethylene oxide, polyprolyleneoxide, urethanes such as various polyurethanes, and may also include polycarbonates, polyolefins, polyetherketones, polyesters, polystyrenes, polyethylstyrene, polysiloxanes, and the like, and copolymers thereof.

As mentioned above, in certain embodiments the polymer includes at least one fluorescent agent or moiety, where in many embodiments at least two fluorescent agents or more are used, for example three, four or more fluorescent agents may be employed. By fluorescent agent is meant any dye, pigment or the like capable of emitting radiation or fluorescence in response to radiation excitation thereof. Typically, the radiation or light absorbed and emitted from the fluorescent agent, i.e., the response radiation, (the wavelength of the response radiation) is chosen to be in the portion of the electromagnetic spectrum to which a photomultiplier tube or the like of an array reader is sensitive and which is intended to be calibrated using a calibration device manufactured according to the subject methods. Usually, the light absorbed and emitted from the fluorescent agent is in the ultraviolet, visible or infrared regions, but may include other wavelengths as well if appropriate.

The particular fluorescent agent(s) used may vary depending on a variety of factors, where such factors include the particular optical reader with which it is intended to be used, the excitation and/or response wavelength, and the like. The fluorophoric moieties or fluorophores of the fluorescent agents, may be cyclic, or polycyclic, particularly polycyclic, aromatic compounds having at least two rings, usually at least three rings and not more than six rings, more usually not more than five rings, where at least two of the rings are fused and in certain embodiments at least three of the rings are fused, where usually not more than four of the rings are fused. The aromatic compounds may be carbocyclic or heterocyclic, e.g., having from one to three, more usually one to two nitrogen atoms as heteroannular atoms. Other heteroannular atoms may include oxygen and sulfur (chalcogen).

The rings may be substituted by a wide variety of substituents, which substituents may include alkyl groups of from about one to about six carbon atoms, e.g., from about one to about two carbon atoms, oxy, which includes hydroxy, alkoxy and carboxy ester, e.g., of from about one to about four carbon atoms, amino, including mono- and disubstituted amino, particularly mono- and dialkyl amino, of from about 0 to about 8, e.g., about 0 to about 6 carbon atoms, thio, particularly alkylthio from 1 to 4, e.g., about 1 to about 2 carbon atoms, sulfonate, including alkylsulfonate and sulfonic acid, cyano, non-oxo-carbonyl, such as carboxy and derivatives thereof, e.g., carboxamide or carboxyalkyl, of from about 1 to about 8 or about 1 to about 6 carbon atoms, e.g., about 2 to about 6 carbon atoms, e.g., about 2 to about 4 carbon atoms, oxo-carbonyl or acyl, e.g., from about 1 to about 4 carbon atoms, halo, e.g., of atomic number 9 to 35, etc.

Specific fluorescent agents of interest that may be employed include at least one of, but are not limited to: xanthene dyes, e.g. fluorescein and rhodamine dyes, such as fluorescein isothiocyanate (FITC), 2-[ethylamino)-3-(ethylimino)-2-7-dimethyl-3H-xanthen-9-yl]benzoic acid ethyl ester monohydrochloride (R6G)(emits a response radiation in the wavelength that ranges from about 500 to 560 nm), 1,1,3,3,3′,3′-Hexamethylindodicarbocyanine iodide (HIDC) (emits a response radiation in the wavelength that ranged from about 600 to 660 nm), 6-carboxyfluorescein (commonly known by the abbreviations FAM and F), 6-carboxy-2,4,7,4,7-hexachlorofluorescein (HEX), 6-carboxy-4′,5′-dichloro-2′,7′-dimethoxyfluorescein (JOE or J), N,N,N′,N′-tetramethyl-6-carboxyrhodamine (TAMRA or T), 6-carboxy-X-rhodamine (ROX or R), 5-carboxyrhodamine-6G (R6G⁵ or G⁵), 6-carboxyrhodamine-6G (R6G⁶ or G⁶), and rhodamine 110; cyanine dyes, e.g. Cy3, Cy5 and Cy7 dyes; coumarins, e.g., umbelliferone; benzimide dyes, e.g., Hoechst 33258; phenanthridine dyes, e.g., Texas Red; ethidium dyes; acridine dyes; carbazole dyes; phenoxazine dyes; porphyrin dyes; polymethine dyes, e.g. cyanine dyes such as Cy3 (emits a response radiation in the wavelength that ranges from about 540 to 580 nm), Cy5 (emits a response radiation in the wavelength that ranges from about 640 to 680 nm), etc; BODIPY dyes and quinoline dyes. Specific fluorophores of interest include: Pyrene, Coumarin, Diethylaminocoumarin, FAM, Fluorescein Chlorotriazinyl, Fluorescein, R110, Eosin, JOE, R6G, HIDC, Tetramethylrhodamine, TAMRA, Lissamine, ROX, Napthofluorescein, Texas Red, Napthofluorescein, Cy3, and Cy5, etc.

In embodiments in which at least two or more fluorescent agents are used, any combination of suitable agents may be used, where particular combinations of interest include R6G, i.e., 2-[ethylamino)-3-(ethylimino)-2-7-dimethyl-3H-xanthen-9-yl]benzoic acid ethyl ester monohydrochloride and HIDC, i.e., 1,1,3,3,3′,3′-Hexamethylindodicarbocyanine iodide; Cy3 (Indocarbocyanine) and Cy5 (Indodicarbocyanine); and other suitable combinations, where combinations of green and red dyes are of particular interest.

In certain embodiments, a fluorescent agent used to as a calibration device coating composition is the same as that which is used in a chemical array assay, e.g., to label a target (for example analogous to a “same-dye reference array” as described for example in US publication No. 2003/0165871). In certain embodiments, a fluorescent agent is one that does not degrade significantly over repeated scans (for example analogous to a “stable-dye reference array” as described for example in US publication No. 2003/0165871).

Embodiments include coating compositions in which the fluorescent agent is distributed substantially uniformly throughout the polymer. In other words, the one fluorescent agent is homogenously dispersed throughout the polymer such that the concentration of the fluorescent agent(s) is substantially constant throughout the polymer in certain embodiments. For example, the at least one fluorescent agent may be distributed throughout the polymer such that the ratio of % fluorescent agent to % polymer for any given volume is substantially the same for all such volumes of a given composition. It will be apparent that if more than one fluorescent layer is used, all fluorescent agents employed will be distributed substantially uniformly throughout the polymer. In certain embodiments, any variation in fluorescent agent distribution that is present may not exceed from about 1 ppm to about 5000 ppm, e.g., may not exceed from about 100 ppm to about 800 ppm, e.g., may not exceed from about 150 ppm to about 80 ppm, where such variation may be determined using fluorescent or absorption measurements employing conventional laboratory instruments (e.g., fluorimeter, UV/V spectrometer, and the like).

The concentration of the fluorescent agent (i.e., the concentration of each fluorescent agent if there is more than one) may vary depending on the particular reader to be calibrated, the type and/or number of fluorescent agents used, etc. In certain embodiments, the concentration of fluorescent agent will range from about 1 ppm to about 5000 ppm, e.g., from about 100 to about 500 ppm, e.g., from about 150 to about 200 ppm. Each fluorescent molecule's concentration will be dependent on its efficiency, i.e., a dye with high quantum efficiency may have a lower concentration than a fluorescent molecule with a lower efficiency. In other words, the calibration compositions should be formulated to provide calibration devices that have a consistent intensity in all wavelength ranges, rather than a consistent number of fluorophores.

The compositions may be prepared in any suitable manner, where methods for preparing such compositions are known in the art. For example, embodiments include preparing a fluorescent dye coating composition through the uniform mixing of the polymer and fluorescent ingredients. In certain embodiments, the ingredients may not be pre-mixed and instead may be dispensed independently from a pulse jet device.

As noted herein, certain embodiments may employ CY3 and/or CY5 in a coating composition. Such coating compositions may be prepared in any suitable manner. For example, aspects may include preparing a suitable CY3 coating composition by adding about 50 μl CY3 (about 50 mole powder with about 0.5 ml 99.9% CAN) to about 25 ml 950 PMMA C4. Aspects may include preparing a suitable CY5 coating composition by adding about 55 W CY5 (about 50 mole powder with about 0.5 ml 99.9% CAN) to about 25 ml 950 PMMA C4.

Once a suitable coating composition is selected and is in fluid communication with a pulse jet deposition device, a volume of the coating composition is dispensed from the pulse jet device so that it is contacted with a substrate surface. To dispense a volume of fluorescent dye coating composition from a pulse jet deposition device onto a substrate surface, the surface and the pulse jet device are positioned relative to each other so that fluid dispensed from the pulse jet will contact the surface, e.g., the surface is positioned relative to the nozzle(s) of the device. For example, the surface may be mounted on a moveable stage and moved in position relative to a pulse jet device positioned above the stage. The substrate may be mounted on a stage capable of movement in the X (right and left) and/or Y (back and forth) and/or Z (up and down) directions. In addition to or instead of the above described approach in which the substrate surface is moved relative to the pulse jet device, the pulse jet device may be moveable relative to the surface (or a combination of the above). For example, the surface may be rotated to the pulse-jet device, which may be moved radially relative to the surface. Movement of a substrate (a substrate stage) and/or pulse jet device (a pulse jet device holder) may be accomplished manually, e.g., with the use of manually actuated control knobs or the like, or automatically by way of an automated driver system controlled, for example, by a processor coupled to a motor system, to facilitate deposition of composition in a larger area of the substrate surface, e.g., across the entire surface.

A variety of substrates, upon which the coating composition is deposited, may be used with the invention, and the size and shape of the substrate and substrate surfaces, and the substrate material, will vary according to the particular reader with which it is to be used. Substrates used in the subject methods may be planar and may be dimensioned for insertion into or onto a chemical array reader, depending on the particular configuration of the chemical array reader. In certain embodiments, a given substrate may be dimensioned analogously to that of an array assembly read by a reader.

Substrates may be flexible or rigid. The substrates may take a variety of configurations ranging from simple to complex. The substrates may be dimensioned to be inserted into, and read by (e.g., scanned by) a chemical array reader. A substrate may have an overall slide or plate configuration, such as a rectangular, square or disc configuration. In many embodiments of the subject invention, the substrate will have a rectangular cross-sectional shape, having a length of from about 4 mm to about 200 mm, e.g., from about 4 to about 150 mm, e.g., from about 4 to about 125 mm; and a width of from about 4 mm to about 200 mm, e.g., from about 4 mm to about 120 mm, e.g., from about 4 mm to about 80 mm; and a thickness of from about 0.01 mm to about 5.0 mm, e.g., from about 0.1 mm to about 2 mm, e.g., from about 0.2 to about 1 mm. The above dimensions are, of course, exemplary only and may vary as required.

The substrates may be fabricated from a variety of materials. In many situations, a suitable substrate material will be transparent to visible and/or 1 W and/or infrared light. For flexible substrates, materials of interest include, for example, nylon, nitrocellulose, polypropylene, polyester films, such as polyethylene terephthalate, polymethyl methacrylate or other acrylics, polyvinyl chloride or other vinyl resin, and the like. Various plasticizers and modifiers may be used with polymeric substrate materials to achieve selected flexibility characteristics. For rigid substrates, specific materials of interest include, for example, silicon; glass; rigid plastics, e.g., polytetrafluoroethylene, polypropylene, polystyrene, polycarbonate, and blends thereof, and the like; metals, e.g. gold, platinum, and the like; etc.

In practicing the subject methods, a plurality of drops of fluorescent dye coating composition are ejected from the same or different nozzles of one or more pulse jet deposition devices. The drops are dispensed in a manner suitable for the drops to coalesce or merge with one another on the substrate surface to form a layer, e.g., thin fluid layer, on the substrate surface. The drops may be dispensed such that upon contact with the surface they overlap one another as shown or may be dispensed such that upon contact the dispensed drops do not initially touch each other, but in any event the drops so dispensed merge together to provide a unitary coating, e.g., a coating of uniform thickness and/or dye concentration in certain embodiments, on at least a portion of the surface. In certain embodiments, the head moves in a predetermined manner across the surface while it dispensed droplets of the coating composition, e.g., may scan across the surface in, e.g., a line-by-line or x-y manner.

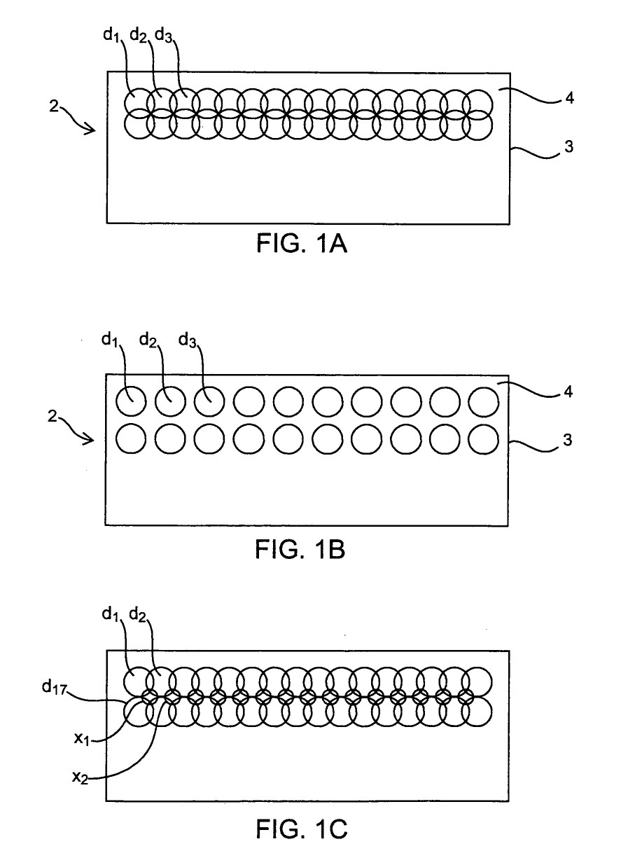

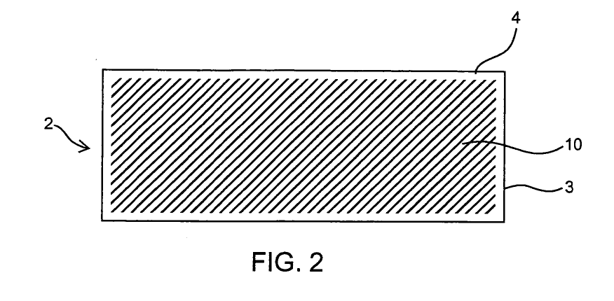

FIG. 1A shows a calibration device embodiment 2 in which droplets d1, d2, d3 . . . have been dispensed from a pulse jet deposition device so that, upon contact with the surface 4 of substrate 3, the droplets contact or touch each other, i.e., overlap each other. FIG. 1B shows calibration device embodiment 2 in which droplets d1, d2, d3 . . . have been dispensed from a pulse jet deposition device so that, upon contact with the surface 4 of substrate 3, the droplets do not contact or touch each other, i.e., do not overlap each other. FIG. 1C shows calibration device embodiment 2 in which droplets of different volumes (droplets d1, d2, d3 . . . are of different volumes than droplets x1, x2, x3 . . . ) have been dispensed from a pulse jet deposition device. In this particular embodiment, the droplets are dispensed in a pattern on the substrate surface such that they initially touch each other, i.e., overlap each other, and droplets x1, x2, x3 . . . are deposited in a manner to fill-in or cover the areas of the substrate surface not initially covered by the overlapping pattern of droplets d1, d2, d3 . . . . Regardless of whether droplets are dispensed according to FIG. 1A, FIG. 1B or 1C or in any other suitable droplet deposition pattern, once contacted with surface 3, the droplets merge together to provide a unitary coating 10, e.g., contiguous coating, on the surface as shown in FIG. 3.

In order for drops to coalesce to provide a coated surface of uniform thickness and/or dye concentration, the droplet volume, density or spacing of the dispensed surface-contacted drops, the distance between the head and the substrate surface, as well as the velocity of the head (if moveable) should be controlled. For example, in embodiments in which the distance of the head from the substrate surface may range from about 100 um to about 1 mm. In certain embodiment, the volume of each droplet deposited at a substrate surface may range from about 1 to about 1000 picoliters or more. In certain embodiments, an average diameter of drop ejected (which is controllable by the power pulse to each jet) may range from about 10 μm to about 100 μm. In certain embodiments a rate of deposition of the drops (firing frequency) by depositing drops as the head is moved over a substrate may range from about 100 hz to about 40 khz. For example, the density of the substrate-contacted drops (i.e., spacing between drops) may range from about 10² to about 10⁶ drops/cm² of substrate surface. Stated otherwise, the volume of coating composition present on the substrate surface may range from about 10⁻³ to about 10⁻¹ cm³/cm² of substrate surface. For embodiments in which an entire surface of a 25 mm by 75 mm substrate (a surface area of 1875 mm²) is coated by dispensing fluid from a pulse jet deposition device, the total volume of fluid dispensed may range from about 0.02 cm³ to about 0.2 cm³.

The area covered by a composition coating may be referred to as a calibration region. The subject methods may be employed to provided a calibration coating composition over the entire surface of a substrate or just a particular portion of the surface, where the portion may range from about 5% to about 100% of the surface's total surface area, e.g., from about 10% to about 90%. For example, for a substrate having a surface having a surface area of about 1875 mm², the coating composition may cover the entire surface area or may cover a portion of the surface. For array readers such as Agilent Technologies array readers, a calibration region may cover a surface area of about 10 μm or greater, in certain embodiments.

In certain embodiments, the fluorescent dye concentration present on the substrate surface may be increased by repeatedly dispensing coating composition over the same surface region one or more times, which may include the entire surface area. For example, a volume of a coating composition having a concentration of fluorescent agent falling within the ranges described herein may be contacted to a surface using a pulse jet as described above. A second volume of the same calibration composition may be dispensed from a pulse jet device at the same location as the previously deposited first volume of the coating composition or at least to a portion of the first contacted location, which repetition of dispensing may be repeated one or more times to produce a coating of fluorescent dye coating composition having a uniform fluorescent dye concentration that ranges from about 1 ppm to about 5000 ppm.

In certain embodiments, there may be two or more calibration regions, which regions may be the same or different (e.g., the thickness of the coatings may differ and/or the dye concentrations may differ and/or the dyes used may differ, etc.). For example, a surface may include calibration regions that are separated by non-calibration regions or by a chemical or structural border such as a trench, ridge, hydrophobic area, hydrophilic area, etc.

In certain embodiments, a substrate surface may include several different intensities, which areas of intensities may be contiguous or may be separated from each other. In any event, a surface having two or more different intensities may be produced by using coating compositions of different fluorescent dye concentrations and/or by repeatedly dispensing coating composition over the same surface region. For example, in certain embodiments a series of heads in fluid communication with different coating compositions may be used to deposit a distribution of calibration regions with varying intensities. Using a combination of fluorescent dye concentrations and repeatedly dispensing coating composition over the same area, a gradient of dye concentration may be provided on the substrate surface.

In any event, once a suitable volume of fluid has been dispensed from a pulse jet device onto the surface of a substrate, the coating composition is dried. For example, in those embodiments in which a plurality of drops of coating composition are dispensed from a pulse jet so that the drops will coalesce and provide a unitary or contiguous coating, which may be a uniform coating in certain embodiments, over a given surface area, the deposited composition will be dried following coalescence of the drops. Drying may be accomplished in any suitable manner, e.g., ambient drying, vacuum drying, forced air oven drying, convection oven drying, or other drying technique may be employed.

The coating composition is dispensed in a manner to provide a coating of suitable thickness for use in calibrating an array reader. In certain embodiments, the thickness of a coating may range from about 1 μm to about 500 μm, e.g., from about 10 μm to about 100 μm. In certain embodiments, the coating composition is dispensed in a manner that coats the surface with the fluorescent dye coating composition in a uniform thickness coating. In other words, the coating of fluorescent dye composition present on the surface of a substrate has a uniform thickness, i.e., the thickness of the coating does not vary significantly across the calibration region. In certain embodiments, the coating composition is dispensed in a manner that coats the surface with the fluorescent dye coating composition in a uniform dye concentration coating. In other words, the coating of fluorescent dye composition present on the surface of a substrate has a uniform dye concentration, i.e., the dye concentration of the coating does not vary significantly across the calibration region.

The concentration of fluorescent agent in the coating may range from about 1 ppm to 5000 ppm, e.g., from about 100 to 500 ppm, e.g., from about 150 to 200 ppm. It will be apparent that the fluorescent agent's concentration may vary, depending on the final thickness of the polymeric coating, where such concentration is determined to provide approximately the same number of fluorescent molecule per unit area regardless of the coating thickness, e.g., a 50 micron film will have a 100 fold more fluorescent molecules than a film having a thickness of 0.5 microns. However, each fluorescent molecule's concentration will be dependent on its efficiency, i.e., a dye with high quantum efficiency may have a lower concentration than a fluorescent molecule with a lower efficiency. In other words, a particular calibration region is manufactured to have a consistent intensity in all wavelength ranges, rather than a consistent number of fluorophores.

In certain embodiments, the local and global fluorescence variations of the coating are minimal, i.e., the local and global nonuniformities are minimal. In general, the local and global nonuniformities are minimized to a degree sufficient to enable calibration, as described below, of the particular optical reader employing a calibration device.

In regards to local nonuniformities, in certain embodiments the difference or deviation between the response radiation or light emitted from each pixel in a certain area of the subject device may be less than about 5%, e.g., less than about 2.5%, e.g., less than about 1%, e.g., less than about 0.7%, 0.5%, 02%, or 0.1%. The local nonuniformity may be based upon a local area having about 5 to about 500 pixels, e.g., about 5 to about 100 pixels, e.g., 5 to about 25, where each pixel may ranges in size from about 2 to about 15 microns, e.g., from about 4 to about 12 microns, e.g., from about 5 to about 10 microns. As such, the response radiation or number of photons emitted from a first pixel may be substantially the same as the number of photons emitted from each of about five to about ten adjacent pixels. In other words, the quantity of light emitted from between about five to about ten substantially adjacent pixels will have minimal variation or nonuniformity, i.e., the variation may be less than about 5%, e.g., less than about 2.5%, e.g., less about 1%.

Embodiments also include minimal global variation or nonuniformity. The exact global nonuniformity requirement may vary depending on a variety of factors. In certain embodiments, the global nonuniformity may be less than about 10%, e.g., less than about 5%, e.g., less than about 4%, e.g., less than about 3%, e.g., less than about 2%, less than about 1%, e.g., less than about 0.5%. In other words, the quantity of light emitted from each local area may be substantially the same as or similar to the quantity of light emitted from each other local area, i.e., the variation or nonuniformity may less than about 10%, e.g., less than about 5%, e.g., less than about 4%, e.g., less than about 3%, e.g., less than about 2%, less than about 1%, e.g., less than about 0.5%.

The subject methods may also include producing at least at least one region on the substrate surface that is absent active fluorescent agent. A fluorescent agent-less region may be a photobleached region and/or a background region.

Embodiments of the subject invention include photobleaching fluorescent agent(s) present in a coating of fluorescent dye composition, where such bleaching reduces or attenuates the fluorescence of the fluorescent agent(s), e.g., by at least about 40% to about 60% in certain embodiments. For example, embodiments include dispensing a volume of fluorescent dye coated composition from a pulse jet onto a surface, as described above and photobleaching at least a portion of the coating on the surface. Embodiments may include producing a plurality of such photobleached regions positioned in predetermined locations on the surface. For example, for embodiments in which a substrate having a width dimensions of about 25 mm and a length dimension of about 75 mm us used, about 1 to about 5000 photobleached regions may be positioned in various locations on the coated substrate surface, e.g., about 200 to about 750 photobleached regions. A photobleached region may have a size of about 1 to about 3 pixels in at least one dimension. For example, in embodiments in which photobleached regions are rectangular in shape, the length may range from about 175 to about 225 microns, e.g., from about 190 to about 210 microns and the may range from about 5 to about 15 microns, e.g., from about 7 to about 9 microns and. For example having about 1000 photobleached regions on a 25 mm by 75 mm substrate, about 250 to about 270 of these may be are positioned horizontally across the fluorescent dye composition coated surface and about 670 to about 690 of these features may be positioned vertically across the fluorescent dye composition coated surface. Device and methods for producing photobleached regions and which may be adapted for use in the subject invention are described, e.g., in commonly owned U.S. application Ser. No. 10/834,423.

Embodiments of the subject methods may also include producing one or more background regions on a given fluorescent dye composition coated substrate that is outside of the calibration area, i.e., an area that does not include fluorescent agents (whether photobleached or not), i.e., that is absent fluorescent agent. A background region may be a region of the substrate other than coated surface of the device, i.e., not on the surface of the device that includes a coating of fluorescent dye coating composition, e.g., one or more edges of the substrate of the substrate.

Fluorescent Dye-Coated Chemical Array Reader Calibration Devices

Also provided are fluorescent dye coated chemical array reader calibration devices manufactured according to the subject methods. As described above, the coated (e.g., uniformly coated in thickness and/or dye concentration in certain embodiments) fluorescent dye coated calibration devices of the subject invention include a substrate having a surface, at least a portion of which includes a coating (e.g., a coating of uniform thickness and/or dye concentration) of fluorescent dye coating composition deposited by ejection of a volume of fluid from a pulse jet deposition device, e.g., a piezoelectric pulse jet device.

The substrates of the subject calibration devices are described in detail above and will not be repeated in detail. In general, a substrate is configured to be used with a chemical array reader, e.g., removably mountable in or on an array reader. In certain embodiments, a calibration device may be dimensioned analogously to a chemical array assembly with which a reader is designed to read. For example, certain array assemblies include a 25 mm by 75 mm planar slide and as such a calibration device may be analogously dimensioned.

As described in great detail above, a volume of fluorescent dye coating composition is dispensed from a pulse jet fluid deposition system to the substrate surface to provide a coating of a continuous region of the surface to provide a calibration region.

Calibration devices may include a calibration coating over the entire surface of a substrate or just a particular portion of the surface, where the portion may range from about 5% to about 100% of the surface's total surface area, e.g., from about 10% to about 90%. For example, for a substrate having a surface having a surface area of about 1875 mm², the coating composition may cover the entire surface area or may cover a portion of the surface. For array readers such as Agilent Technologies array readers, a calibration region may cover a surface area of about 10 μm or greater, in certain embodiments. However, calibration regions having surface area dimensions less than or greater than 10 μm may also be used.

Calibration devices include a calibration coating of suitable thickness for use in calibrating an array reader. In certain embodiments, the thickness of a coating may range from about 0.01 mm to about 5.0 mm, e.g., from about 0.1 mm to about 2 mm, e.g., from about 0.2 to about 1 mm. In certain embodiments, the coating on the surface is a uniform coating of uniform thickness.

Embodiments include coatings in which the fluorescent agent is distributed uniformly throughout the calibration region. In certain embodiments, any variation in fluorescent agent distribution that is present may not exceed from about 1 ppm to about 5000 ppm, e.g., may not exceed from about 100 ppm to about 800 ppm, e.g., may not exceed from about 150 ppm to about 180 ppm.

The concentration of the fluorescent agent (i.e., the concentration of each fluorescent agent if there is more than one) in a calibration coating may vary depending on the particular reader to be calibrated, the type and/or number of fluorescent agents used, etc. In certain embodiments, the concentration of fluorescent agent may range from about 1 ppm to about 5000 ppm, e.g., from about 100 to about 500 ppm, e.g., from about 150 to about 200 ppm. As noted above, each fluorescent molecule's concentration will be dependent on its efficiency, i.e., a dye with high quantum efficiency may have a lower concentration than a fluorescent molecule with a lower efficiency. In other words, the subject calibration devices have a consistent intensity in all wavelength ranges, rather than a consistent number of fluorophores.

In certain embodiments, there may be two or more calibration coating regions and/or a given surface may include two or more different concentrations of fluorescent agent, continuous with each other or separated. For example, a surface may include two or more calibration regions that are the same, or which may differ in one or more respects, e.g., differ in concentration of fluorescent agent, differ in the type of fluorescent agent used, differ in thickness of the coating, etc. A surface may include a gradient of fluorescent dye concentration.

As described above, a subject calibration device may include one or more regions that are absent fluorescent agent, e.g., one or more photobleached areas. Embodiments may also include one or more background regions.

Methods of Calibrating a Chemical Array Reader

As summarized above, the subject invention also provides methods for calibrating a chemical array reader, e.g., a chemical array imager or scanner, using a fluorescent dye coated chemical array reader calibration device manufactured according to the subject methods. The subject invention may be employed to calibrate a wide variety of array readers. Representative array readers include those described in U.S. Pat. Nos. 5,091,652; 5,585,639; 5,760,951; 5,763,870; 5,837,475; 6,084,991; 6,222,664; 6,284,465; 6,320,196; 6,329,196; 6,366,365; 6,371,370; 6,355,934 and 6,406,849. For example, an exemplary array scanner that may be calibrated according to the subject invention is an Agilent MICROARRAY SCANNER available from Agilent Technologies, Palo Alto, Calif.

In general, a fluorescent dye composition coated surface of a calibration device is illuminated with light from at least one light source. In other words, the surface of the calibration device that includes the coating of fluorescent dye coating composition is illuminated with at least one light source and fluorescent data from the surface is obtained and the reader may be calibrated according to the obtained fluorescence. It will be apparent that in certain instances calibration may not be performed in those instances where a reader is determined to be calibrated using a fluorescent dye coated chemical array reader calibration device). Methods for calibrating a chemical array reader which may be adapted for use with the subject invention are described, e.g., in US publication No. 20030165871, U.S. patent application Ser. Nos. 10/834,423 and 10/008598, and U.S. Pat. Nos. 6,440,669 and 6,770,892.

In certain embodiments, a fluorescent dye coated chemical array reader calibration device is positioned on a support stage or the like such that the substrate side of the device (as distinguished from the fluorescent dye coated side) is faced up or opposite the light source. In other words, light may be directed first through the substrate side of a subject calibration device. An optical system of the reader is then confirmed (in other words no adjustments are made as it is determined that the reader is calibrated) or the reader is adjusted or calibrated based upon the fluorescence data obtained from the calibration device. Adjustments or calibration may be with respect to any aspect or component of a reader such as, but not limited to, one or more of the following: (1) scale factor (e.g., the sensitivity of the optical detector may be adjusted), (2) the focus position (e.g., the distance between the stage and one or more lenses of the system may be adjusted), (3) the dynamic focus (e.g., the rate of speed the stage travels may be adjusted), (4) the scanner mirror (e.g., the synchronicity of the light beam(s) may be adjusted), and the (5) the jitter.

Thus, the first step in all of the subject methods for calibrating or adjusting certain optical components of an optical scanning system is to illuminate a surface with at least one light source, and more particularly irradiate a fluorescent dye coated calibration surface with a source of excitation radiation. In other words, a surface of a calibration device is irradiated with one or more light beams having specific wavelengths, where the one or more light beams are used to excite the one or more fluorescent agents associated with the surface being illuminated. Unless otherwise noted, the surface read or scanned is usually a non-photobleached area. For example, to calibrate a detector and/or lens and/or stage and/or mirror, etc., the surface of the calibration device read or scanned does not include photobleached regions in that either the calibration device does not include photobleached regions or such photobleached areas are not scanned or the data therefrom is not used in the subject methods to calibrate the optical detector, lens, stage and mirror. However, when calibrating jitter, the area(s) scanned are photobleached areas. As mentioned above, in certain embodiments the illumination light may directed through the substrate side of the calibration device first, i.e., light is directed through the substrate and then to the coated side.

Each light source employed may provide a coherent light beam, e.g., the light source may be a laser light source, and the like. In certain embodiments, the light sources may include two laser light sources or a light source that produces two different beams of light (i.e., beams of light of two different wavelengths, e.g., a red laser light source and a green laser light source).

Each light beam may have an excitation wavelength that is within the ultraviolet, visible or infrared spectrum for illuminating the surface of the calibration device. In general, the at least one light beam illuminates the surface with light of a selected wavelength, where the selected wavelength is usually at or near the absorption maximum of the particular fluorescent agent being illuminated or excited. Illuminating or exciting a fluorescent agent at such a wavelength produces the maximum number of photons emitted at the emission wavelength. In certain embodiments of the subject methods, light beams from at least two light sources are used, where the light beams from the various light sources are of different wavelengths, and each source may correspond to fluorescent excitations of the different fluorescent agents being illuminated and excited. In other words, the wavelengths of the light beams are at or near the absorption maximum of the fluorescent agents illuminated. For example, light from a first light source may illuminate the surface with light in a wavelength ranging from about 500 to 560 nm corresponding to the fluorescence excitation of about 500 to 560 nm of a first fluorescent agent, e.g., of 2-[ethylamino)-3-(ethylimino)-2-7-dimethyl-3H-xanthen-9-yl]benzoic acid ethyl ester monohydrochloride, and light from a second light source may illuminate the surface with light in a wavelength ranging from about 600 to 660 nm corresponding to the fluorescence excitation of about 600 to 660 nm of a second fluorescent agent, e.g., 1,1,3,3,3′,3′-Hexamethylindodicarbocyanine iodide. Where more than one light source is used, the light sources may illuminate the surface at the same or different time, where in certain embodiments the light sources will illuminate the surface simultaneously.

In certain embodiments the entire fluorescent dye coated regions(s) of the substrate surface (excluding the photobleached regions, if present, as mentioned above) is illuminated by the at least one light source. For example, an illumination area may be as great as about 70% or more of the entire surface area, usually as great as about 75% ore more of the entire area and more usually as great as about 80% or more of the entire area is illuminated. In other words, usually one or more light beams are swept or rastered across a substrate surface, or at least across the one or more regions that include the calibration coating, as opposed to simply illuminating one discrete region. For example, in those embodiments using a calibration device as described above, e.g., a 25 mm by about 75 mm calibration device, one or more light beams may scan or raster over an area (a calibration area) having a width ranging from about 10 to about 30 mm, e.g., about 15 to about 25 mm and a length ranging from about 50 to about 70 mm, e.g., from about 55 to about 65 mm. In those embodiments in which the calibration device has dimensions of about 22 mm by about 22 mm, one or more light beams may scan or sweep over an area having a width ranging from about 10 to about 20 mm, e.g., about 15 to about 20 mm and a length ranging from about 10 to about 20 mm, e.g., from about 15 to about 20 mm, where such illumination usually occurs in a predefined pattern, oftentimes in a linear pattern. The surface may be illuminated by more than one light source at the same or different times. In other words, a surface or a region of the surface may first be illuminated by a first light source and then subsequently illuminated by a second light source. A two color, simultaneous illumination or scan of a 25 mm by 75 mm surface may be performed in about 5 to about 10 minutes, e.g., in about 7 to about 9 minutes.

Once the calibration surface has been excited by one or more light sources, fluorescence is detected from the calibration surface. More specifically, data are acquired from the calibration surface, where such data corresponds to the light emitted, i.e., the intensity of light emitted, from the at least one fluorescent agent associated with the surface. Thus, one or more fluorescent agents are excited by the illumination from the one or more light beams, where each fluorescent agent emits light of a certain wavelength, at a certain intensity. The intensity of light emitted from each pixel is detected and measured by an optical detector such as a photomultiplier tube (PMT) or the like, where the PMT generates a current proportional to the number of photons that reach it. The PMT may generate a current ranging from about 500 nanoamps to about 50 microamps within its range of operation, more usually from about 1 microamp to about 10 microamps. Output from the detector is used to calibrate the array reader, such as the detector, or make certain other optical system adjustments, as noted above, where the adjustments may be made manually or automatically, for example by a coupled processor.

Embodiments of the subject invention also include background subtraction methods for subtracting a value from the emitted fluorescence values, where such subtracted value corresponds to background signal. Background signal may be a function of the “noise” of the optical scanner, the polymeric material, the substrate material, particular solutions, electronic noise, reflections or scattering from surface or particles, and the like.

Accordingly, embodiments include determining the background signal, where the background signal may be defined as signal generated from outside of the calibration area, i.e., does not include fluorescent agents (whether photobleached or not). Usually, a background region will be a region of the calibration device off of the calibration coated surface, i.e., not on the surface, of a calibration device being scanned, e.g., one or more edges of the substrate of the calibration device, negative space such as air space, and the like.

The signal from a background area may be detected by an optical detector and transmitted to a processor for processing, e.g., to provide a statistically relevant background value. In certain embodiments, the background signal may be predetermined and stored in the memory of a reader. Regardless of whether the background signal is determined or predetermined, the background signal may be subtracted from the value corresponding to the intensity of light emitted from the fluorescent calibration regions (photobleached and/or non-photobleached areas) on the calibration device. The final value represents a background corrected signal corresponding to the intensity of light per pixel due to the fluorescent agent.

Methods of Performing a Chemical Array Assay

Also provided by the subject invention are methods of using a calibrated chemical array scanner, calibrated according to the subject invention, in a chemical array assay.

Chemical Arrays

Chemical arrays find use in a variety of applications, including gene expression analysis, drug screening, nucleic acid sequencing, mutation analysis, and the like. These chemical arrays include a plurality of ligands or molecules or probes (i.e., binding agents or members of a binding pair) deposited onto the surface of a substrate in the form of an “array” or pattern.

Chemical arrays include at least two distinct polymers that differ by monomeric sequence attached to different and known locations on the substrate surface. Each distinct polymeric sequence of the array is typically present as a composition of multiple copies of the polymer on a substrate surface, e.g., as a spot or feature on the surface of the substrate. The number of distinct polymeric sequences, and hence spots or similar structures, present on the array may vary, where a typical array may contain more than about ten, more than about one hundred, more than about one thousand, more than about ten thousand or even more than about one hundred thousand features in an area of less than about 20 cm² or even less than about 10 cm². For example, features may have widths (that is, diameter, for a round spot) in the range from about 10 μm to about 1.0 cm. In other embodiments, each feature may have a width in the range from about 1.0 μm to about 1.0 mm, usually from about 5.0 μm to about 500 μm and more usually from about 10 μm to about 200 μm. Non-round features may have area ranges equivalent to that of circular features with the foregoing width (diameter) ranges. At least some, or all, of the features are of different compositions (for example, when any repeats of each feature composition are excluded, the remaining features may account for at least about 5%, 10% or 20% of the total number of features). Interfeature areas will typically (but not essentially) be present which do not carry any polynucleotide (or other biopolymer or chemical moiety of a type of which the features are composed). It will be appreciated though, that the interfeature areas, when present, could be of various sizes and configurations. The spots or features of distinct polymers present on the array surface are generally present as a pattern, where the pattern may be in the form of organized rows and columns of spots, e.g. a grid of spots, across the substrate surface, a series of curvilinear rows across the substrate surface, e.g. a series of concentric circles or semi-circles of spots, and the like.

An array includes any one or two-dimensional or substantially two-dimensional (as well as a three-dimensional) arrangement of addressable regions bearing a particular chemical moiety or moieties (e.g., biopolymers such as polynucleotide or oligonucleotide sequences (nucleic acids), polypeptides (e.g., proteins), carbohydrates, lipids, etc.) associated with that region. In the broadest sense, the arrays are arrays of polymeric or biopolymeric ligands or molecules, i.e., binding agents, where the polymeric binding agents may be any of: peptides, proteins, nucleic acids, polysaccharides, synthetic mimetics of such biopolymeric binding agents, etc. In many embodiments, the arrays are peptide arrays and arrays of nucleic acids, including oligonucleotides, polynucleotides, cDNAs, mRNAs, synthetic mimetics thereof, and the like.

A variety of solid supports or substrates may be used, upon which an array may be positioned, as described above. In certain embodiments, a plurality of arrays may be stably associated with one substrate. For example, a plurality of arrays may be stably associated with one substrate, where the arrays are spatially separated from some or all of the other arrays associated with the substrate.

Each array may cover an area of less than about 100 cm², or even less than about 50 cm², 10 cm² or 1 cm². In many embodiments, the substrate carrying the one or more arrays will be shaped generally as a rectangular solid (although other shapes are possible), having a length of more than about 4 mm and less than about 1 m, usually more than about 4 mm and less than about 600 mm, more usually less than about 400 mm; a width of more than about 4 mm and less than about 1 m, usually less than about 500 mm and more usually less than about 400 mm; and a thickness of more than about 0.01 mm and less than about 5.0 mm, usually more than about 0.1 mm and less than about 2 mm and more usually more than about 0.2 and less than about 1 mm. Substrates having shapes other than rectangular may have analogous dimensions. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least about 20%, or about 50% (or even at least about 70%, 90%, or 95%), of the illuminating light incident on the substrate as may be measured across the entire integrated spectrum of such illuminating light or alternatively at 532 nm or 633 nm.

Chemical Array Assays

Array assemblies find use in a variety of different applications, where such applications include analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array may be labeled prior to or after contact, e.g., hybridization, with the array. In some embodiments, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence. In certain embodiments, the fluorescent agent used as a calibration device coating composition is the same as that used as a label.

Following sample preparation (labeling, pre-amplification, etc.), the sample may be introduced to the array using any convenient protocol, e.g., sample may be introduced using a pipette, syringe or any other suitable introduction protocol. The sample is contacted with the array under appropriate conditions to form binding complexes on the surface of the substrate by the interaction of the surface-bound probe molecule and the complementary target molecule in the sample. The presence of target/probe complexes, e.g., hybridized complexes, may then be detected.

In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample.

The array is incubated with the sample under appropriate array assay conditions, e.g., hybridization conditions, as mentioned above, where conditions may vary depending on the particular biopolymeric array and binding pair.

Once the incubation step is complete, the array is typically washed at least one time to remove any unbound and non-specifically bound sample from the substrate, generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such as sodium, sodium phosphate (SSP) and sodium, sodium chloride (SSC) and the like as is known in the art, at different concentrations and which may include some surfactant as well. In certain embodiments the wash conditions described above may be employed.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using calorimetric, fluorimetric, chemiluminescent, bioluminescent means or other appropriate means. The obtained signal data from the reading may be in any convenient form, i.e., may be in raw form or may be in a processed form. A feature of the subject array assay methods is that the array reader employed to read the array is one that has been calibrated according to the subject methods.

Reading of the array(s) to obtain signal data may be accomplished by illuminating the array(s) and reading the location and intensity of resulting fluorescence (if such methodology was employed) at each feature of the array(s) to obtain a result. For example, an array scanner may be used for this purpose that is similar to the Agilent MICROARRAY SCANNER available from Agilent Technologies, Palo Alto, Calif. Other suitable apparatus and methods for reading an array to obtain signal data are described in U.S. patent application Ser. Nos 09/846125 “Reading Multi-Featured Arrays” by Dorsel et al.; and Ser. No. 09/430214 “Interrogating Multi-Featured Arrays” by Dorsel et al., the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

Results of the array reading (processed or not) may be forwarded (such as by communication) to a remote location if desired, and received there for further use (such as further processing). The data may be transmitted to the remote location for further evaluation and/or use. Any convenient telecommunications means may be employed for transmitting the data, e.g., facsimile, modem, Internet, etc.

As noted above, arrays may be employed in a variety of array assays including hybridization assays. Specific hybridization assays of interest include: gene discovery assays, differential gene expression analysis assays; nucleic acid sequencing assays, and the like. Patents describing methods of using arrays in various applications include: U.S. Pat. Nos. 5,288,644; 5,324,633; 5,432,049; 5,470,710; 5,492,806; 5,503,980; 5,525,464; 5,580,732; and 5,661,028.

Other array assays of interest include those where the arrays are arrays of polypeptide binding agents, e.g., protein arrays, where specific applications of interest include analyte detection/proteomics applications, including those described in U.S. Pat. No. 4,591,570; 5,171,695; 5,436,170; 5,486,452; 5,532,128; and 6,197,599; as well as published PCT application Nos. WO 99/39210; WO 00/04832; WO 00/04389; WO 00/04390; WO 00/54046; WO 00/63701; WO 01/14425; and WO 01/40803.

Kits

In aspects of the subject invention, one or more fluorescent dye-coated chemical array reader calibration devices produced in accordance with the subject invention may be present in a kit format. A kit may also include a chemical array. The subject kits may also include instructions for how to the one or more fluorescent dye-coated chemical array reader calibration devices to calibrate a chemical array reader. The instructions may be recorded on a suitable recording medium or substrate. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

The kits may further include one or more additional components necessary for carrying out an array assay, such as sample preparation reagents, buffers, labels for labeling components of interest of a sample such as for labeling a nucleic acid or the like, etc. As such, the kits may include one or more containers such as vials or bottles, with each container containing a separate component for the measurement of an optical property of a sample.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of manufacturing a calibration device for a chemical array reader, said method comprising:
dispensing a volume of fluorescent dye coating composition from a pulse jet fluid deposition device onto a surface of a substrate to coat at least a region of said surface with a coating of said fluorescent dye coating composition to produce said calibration device.

2. The method of claim 1, wherein said method comprises dispensing a plurality of droplets of said fluorescent dye coating composition from said pulse jet fluid deposition device.

3. The method of claim 2, wherein the volume of each droplet of said plurality ranges from about 1 to about 1000 picoliters.

4. The method of claim 3, wherein all of the droplets have the same volume of said fluorescent dye coating composition.

5. The method of claim 3, wherein at least two of the droplets have different volumes of said fluorescent dye coating composition

6. The method of claim 1, wherein said coating has a thickness that ranges from about 1 μm to about 500 μm.

7. The method of claim 1, wherein said coating has a concentration of fluorescent dye that ranges from about 1 ppm to about 5000 ppm.

8. The method of claim 7, wherein said dispensing comprises coating said surface with a gradient of concentration of fluorescent dye.

9. The method of claim 1, further comprising repeating said dispensing step at least once.

10. The method of claim 9, wherein said method comprises dispensing first and second volumes of said fluorescent dye coating composition having different concentrations of fluorescent dye.

11. The method of claim 10, wherein said first and second volumes are dispensed onto different regions of said surface.

12. The method of claim 10, wherein said first and second volumes are dispensed onto the same region of said surface.

13. The method of claim 9, wherein said method comprises dispensing first and second volumes of said fluorescent dye coating composition having the same concentration of fluorescent dye.

14. The method of claim 13, wherein said first and second volumes are dispensed onto different regions of said surface.

15. The method of claim 13, wherein said first and second volumes are dispensed onto the same region of said surface.

16. The method of claim 1, wherein said fluorescent dye coating composition comprises a polymer and at least one fluorescent agent.

17. The method of claim 16, wherein said polymer is selected from the group consisting of acrylates, epoxides, urethanes, polycarbonates, polyolefins, polyetherketones, polyesters, polystyrenes, polyethylstyrene, polysiloxanes, and copolymers thereof.

18. The method of claim 17, wherein said polymer is polymethyl-methacrylate.

19. The method of claim 1, further comprising providing at least one region on said substrate surface that is absent fluorescent dye.

20. The method of claim 19, wherein said providing comprises photobleaching said at least one region.

21. The method of claim 1, wherein said fluorescent dye coating composition does not comprise nucleic acids.

22. A chemical array reader calibration device comprising a coating of fluorescent dye coating composition fabricated according to the method of claim 1.

23. The calibration device of claim 22, wherein said device comprises first and second calibration regions having different concentrations of fluorescent dye.

24. The calibration device of claim 19, wherein said coating has a thickness that ranges from about 1 μm to about 500 μm.

25. The calibration device of claim 24, wherein said coating has a uniform thickness.

26. The calibration device of claim 22, wherein said coating has a concentration of fluorescent dye that ranges from about 1 ppm to about 5000 ppm.

27. The calibration device of claim 26, wherein said coating comprises a gradient of concentration of fluorescent dye.

28. The calibration device of claim 26, wherein said fluorescent dye is uniformly distributed in said coating.

29. A method for calibrating a chemical array reader, said method comprising:
(a) illuminating a surface of a chemical array reader calibration device according to claim 22 with light;
(b) obtaining fluorescence data from said surface of said calibration device; and
(c) calibrating said chemical array reader based on said obtained fluorescence.

30. A method for performing a chemical array assay, said method comprising:
(a) calibrating a chemical array reader with a chemical array reader calibration device according to claim 22 to provide a calibrated array reader;
(b) contacting a sample with a chemical array; and
(c) reading said chemical array with said calibrated array reading to obtain a result.

31. A method comprising transmitting a result obtained from a method according to claim 30 from a first location to a second location.

32. The method of claim 31, wherein said second location is a remote location.

33. A method comprising receiving a result of a method of claim 30.

34. A kit comprising:
(a) a chemical array reader calibration device according to claim 22; and
(b) a chemical array.
